(19) United States
(12) Patent Application Publication
(10) Pub. No.: US 2025/0259056 A1
(43) Pub. Date: Aug. 14, 2025

(54) METHOD AND SYSTEM FOR FILL LEVEL DETERMINATION

(71) Applicant: Compology LLC, Pittsburgh, PA (US)

(72) Inventors: Justin Armstrong, Pittsburgh, PA (US); Shandy Brown, Pittsburgh, PA (US); Mark Stefanski, Pittsburgh, PA (US); Matthew Duncan, Pittsburgh, PA (US)

(73) Assignee: Compology LLC, Pittsburgh, PA (US)

(21) Appl. No.: 19/051,488

(22) Filed: Feb. 12, 2025

Related U.S. Application Data
(63) Continuation of application No. 17/161,437, filed on Jan. 28, 2021, now Pat. No. 12,254,403.
Application No. 17/161,437 is a continuation-in-part of application No. 16/709,127, filed on Dec. 10, 2019, now Pat. No. 10,943,356.
(60) Provisional application No. 62/778,775, filed on Dec. 12, 2018.

(51) Int. Cl. G06N 3/08; G06F 18/21; G06F 18/214; G06F 18/241; G06T 7/00; G06V 10/764; G06V 20/52; G06V 20/64

(52) U.S. Cl. CPC G06N 3/08; G06F 18/2148; G06F 18/2193; G06F 18/241; G06T 7/001; G06V 10/764; G06V 20/52; G06V 20/64; G06T 2207/20084; G06T 2207/30164; G06T 2207/30232

(57) ABSTRACT

A method for fill level determination, which can include receiving a set training set, training a neural network, selecting reference images, and/or determining a container fill level. A system for fill level determination, which can include a computing system, one or more containers, and/or one or more content sensors.

### CROSS-REFERENCE TO RELATED APPLICATIONS

This application is a continuation-in-part of U.S. application Ser. No. 16/709,127, filed 10 Dec. 2019, which claims the benefit of U.S. Provisional Application No. 62/778,775, filed 12 Dec. 2018, each of which is incorporated in its entirety by this reference.

This application is related to U.S. application Ser. No. 17/145,021 filed 08 Jan. 2021, which is a continuation-in-part of U.S. application Ser. No. 16/570,936 filed 07 Nov. 2019, which is a continuation-in-part of U.S. application Ser. No. 16/288,593 filed 28 Feb. 2019, which is a continuation of U.S. application Ser. No. 14/479,136 filed 05 Sep. 2014, which is a continuation-in-part of U.S. application Ser. No. 14/211,709 filed 14 Mar. 2014, which claims the benefit of U.S. Provisional Application No. 61/801,021 filed 15 Mar. 2013, and also which claims the benefit of U.S. Provisional Application Ser. No. 62/731,249 filed 14 Sep. 2018, and U.S. Provisional Application Ser. No. 62/795,957 filed 23 Jan. 2019, each of which is incorporated in its entirety by this reference.

### TECHNICAL FIELD

This invention relates generally to the image analysis field, and more specifically to a new and useful method and system for fill level determination in the image analysis field.

### BRIEF DESCRIPTION OF THE FIGURES

FIG. 1 is a schematic representation of an embodiment of the method.

FIG. 2 is a schematic representation of an embodiment of the system.

FIGS. 3A-3C are schematic representations of various examples of one or more content sensors coupled to a container.

FIGS. 4A-4B are depictions of subsets associated with a first and second container, respectively, of an example of a training set.

FIG. 5 is a schematic representation of an embodiment of a neural network.

FIG. 6 is a schematic representation of an example of a convolutional neural network.

FIG. 7 is a schematic representation of an example of selecting a reference image.

FIG. 8 is a schematic representation of an example of determining a container fill level.

FIG. 9 is a schematic representation of an embodiment of determining a container fill level.

FIGS. 10A-10B are schematic representations of use of a first and second training function, respectively, for neural network training.

FIG. 11 is a depiction of a subset, associated with a first container, of an example of a training set.

FIG. 12 is a schematic representation of an embodiment of a diverter neural network.

FIG. 13 is a schematic representation of an embodiment of chained neural networks.

FIGS. 14A-14B are depictions of an example of a reference image and a subject image, respectively, of a container.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

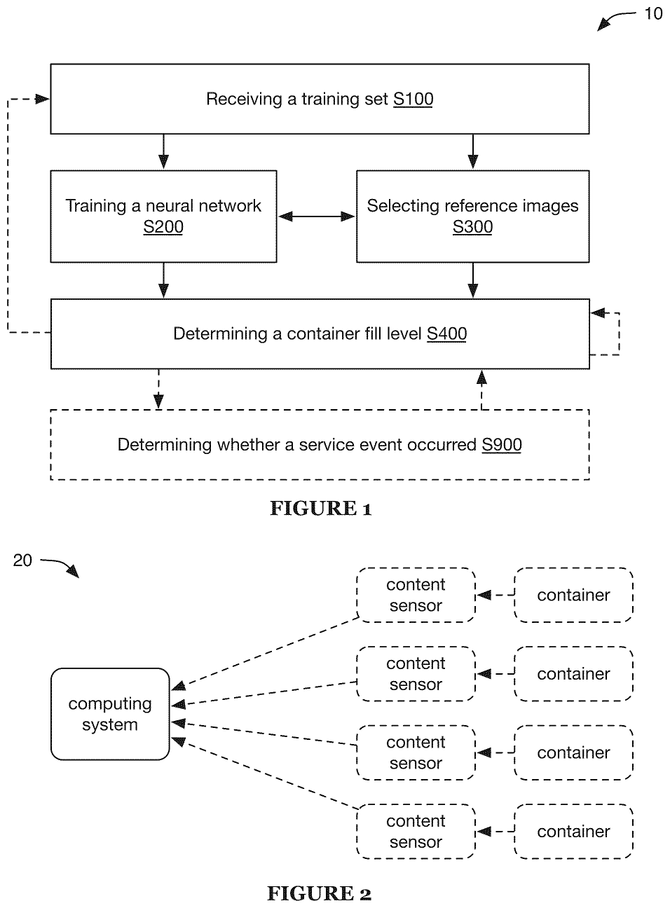

A method 10 for fill level determination preferably includes receiving a training set S100, training a neural network S200, selecting reference images S300, and/or determining a container fill level S400 (e.g., as shown in FIG. 1). However, the method 10 can additionally or alternatively include any other suitable elements.

A system 20 for fill level determination preferably includes a computing system (e.g., remote server), and can additionally or alternatively include one or more containers, one or more content sensors (e.g., imaging devices) associated with each container, and/or any other suitable elements (e.g., as shown in FIG. 2).

The method 10 is preferably performed using the system 20, but can additionally or alternatively be performed by any other suitable system.

### 2. System

The containers can include dumpster (e.g., front load containers, roll off containers, etc.), shipping containers (e.g., intermodal freight container, unit load device, trailer or semi-trailer, etc.), sections of a vehicle (e.g., land, sea, air, and/or space vehicle) such as vehicle cargo holds, rooms of a structure (e.g., a fixed structure such as a building), and/or any other suitable containers.

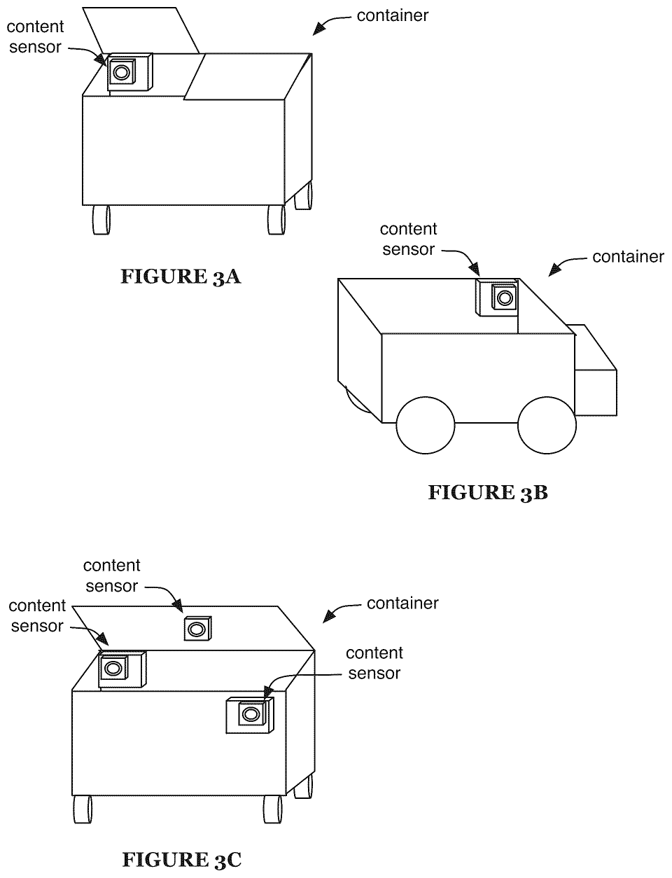

The content sensor is preferably configured to sense (e.g., image) the interior of the container that it is associated with (e.g., image and/or otherwise sense the contents of the container), more preferably configured to sense substantially all of the interior but alternatively configured to image any suitable portion thereof. The content sensor preferably has a fixed position and/or orientation relative to the container (e.g., is mechanically coupled to the container, preferably by a fixed coupling) but can alternatively have any other suitable spatial relationship with respect to the container (e.g., as shown in FIGS. 3A-3C).

The content sensor preferably includes one or more imaging devices. The imaging device is preferably an optical sensor (e.g., camera), but can additionally or alternatively include an ultrasound imaging device and/or any other suitable imaging devices. Examples of optical sensors include a monocular camera, stereocamera, multi-lens or multi-view camera, color camera (e.g., a RGB camera) such as a charge coupled device (CCD) or a camera including a CMOS sensor, grayscale camera, multispectral camera (narrow band or wide band), hyperspectral camera, ultraspectral camera, spectral camera, spectrometer, time of flight camera, high-, standard-, or low-dynamic range cameras, range imaging system (e.g., LIDAR system), active light system (e.g., wherein a light, such as an IR LED, is pulsed and directed at the subject and the reflectance difference measured by a sensor, such as an IR sensor), thermal sensor, infra-red imaging sensor, projected light system, full spectrum sensor, high dynamic range sensor, or any other suitable imaging system. The optical sensor is preferably configured to capture a 2-dimensional or 3-dimensional image, but can alternatively capture any a measurement having any other suitable dimension. The image is preferably single, multi-pixel, time-averaged or sum total measurement of the intensity of a signal emitted or reflected by objects within a field of view, but can alternatively be a video (e.g., a set of images or frames), or any other suitable measurement. The image preferably has a resolution (e.g., cycles per millimeter, line pairs per millimeter, lines of resolution, contrast vs. cycles/mm, modulus of the OTF, or any other suitable measure) capable of resolving a 1 cm³ object at a sensor distance of at least 10 feet from the object, but can alternatively have a higher or lower resolution.

The content sensor can optionally include one or more emitters that are configured to emit electromagnetic signals, audio signals, compounds, or any other suitable interrogator that the content sensor is configured to measure. However, the content sensor can additionally or alternatively measure signals from the ambient environment. Examples of sensor-emitter pairs include LIDAR systems, time-of-flight systems, ultrasound systems, radar systems, X-ray systems, and/or any other suitable systems. In embodiments in which the content sensor includes an emitter, the content sensor can optionally include a reference sensor that measures the ambient environment signals (e.g., wherein the content sensor measurement can be corrected by the reference sensor measurement).

The content sensor can optionally include a lens that functions to adjust the optical properties of the incident signal on the sensor. For example, the optical sensor can include a fish-eye lens to broaden the area monitored by the optical sensor, wherein the resultant distortion is known and can be adjusted for during image processing. However, the lens can be a wavelength filter, polarizing filter, or any other suitable lens. The content sensor can additionally or alternatively include a physical or digital filter, such as a noise filter that corrects for interferences in the measurement.

The content sensors can optionally include one or more communication modules. The communication module preferably functions to communicate data from the content sensor to a second system (e.g., the computing system). The data can be measurements from the content sensor (and/or any other suitable components), processed measurements, instructions, pickup requests, and/or any other suitable data. The second system can be a device, server system, or any other suitable computing system. The second system can be remote or wired to the communication system. Examples of the second system include a mobile device (e.g., smartphone, tablet, computer), server system, or any other suitable computing system. The communication system can be a wireless or wired communication system. The communication system can be a cellular, WiFi, Zigbee, Z-Wave, near-field communication system (e.g., Bluetooth, RF, NFC, etc.), Ethernet, powerline communication, or any other suitable communication system. The communication system is preferably operable in a standby or off mode, wherein the communication system consumes power at a rate less than a threshold rate, and an on or communication mode, wherein the communication system consumes power at a rate required to communicate data. However, the communication system can be operable in any other suitable mode.

The content sensor can optionally include one or more auxiliary sensors, such as IMU sensors (e.g., accelerometer, gyroscope, magnetometer, etc.), geopositioning elements (e.g., GPS receiver), weight sensors, audio sensors, and/or any other suitable auxiliary sensors. However, the imaging devices can additionally or alternatively include any other suitable elements in any suitable arrangement.

### 3. Method

### 3.1 Receiving a Training Set

Receiving a training set S100 preferably functions to provide a set of input data for training a fill level determination model (i.e., fullness model).

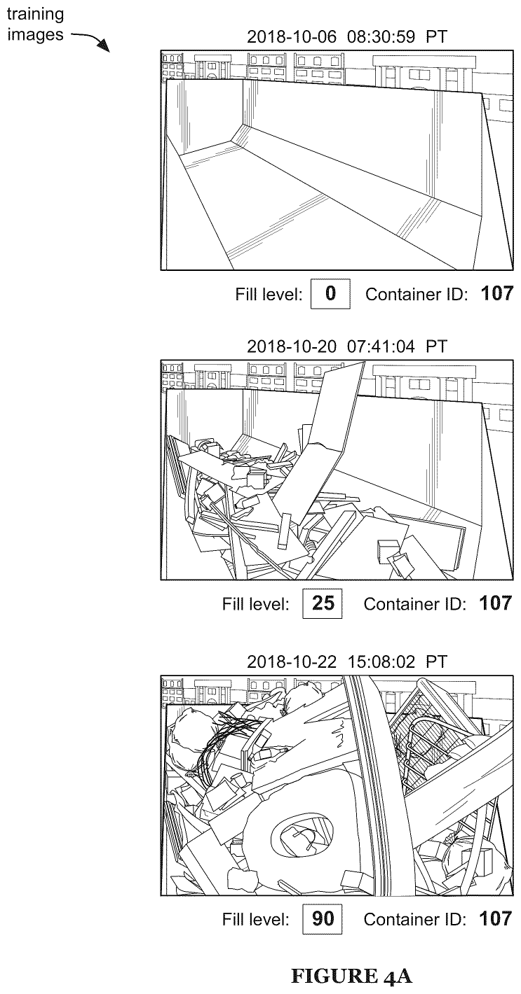

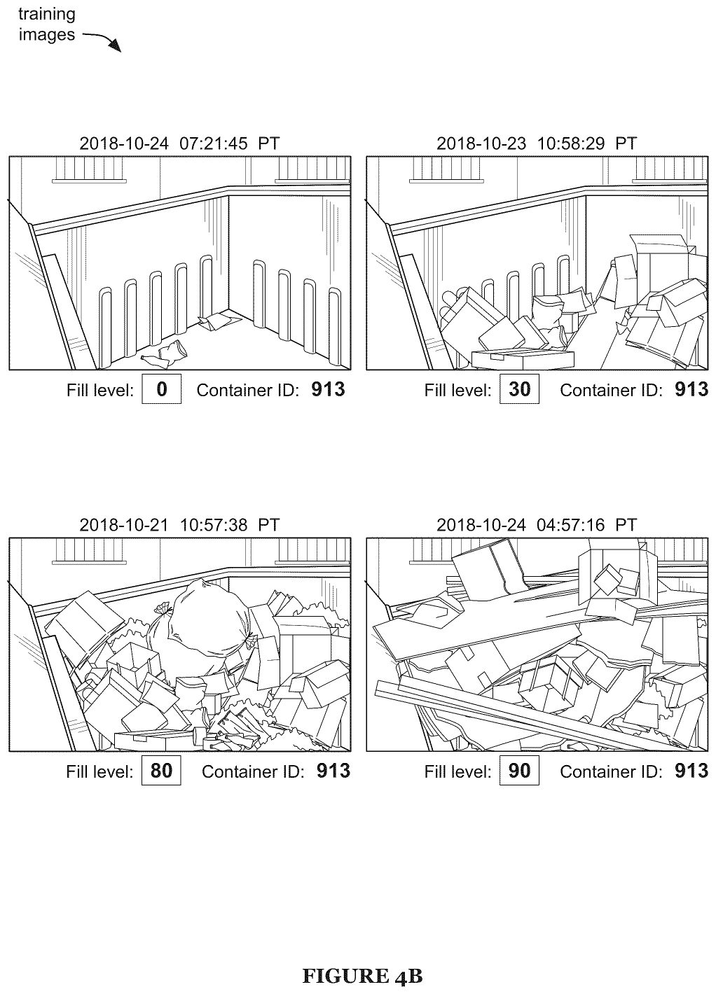

The training set preferably includes a plurality of images. Each image is preferably associated with a container (e.g., by a container ID associated with the image). The training set preferably includes a plurality of images from each of a plurality of containers (e.g., as shown in FIGS. 4A-4B). The plurality of containers preferably includes containers of different types (e.g., roll-off container, front load container, etc.). However, the training set can alternatively include images of a single type of container (e.g., wherein the training set is intended for use in training a neural network to determine the fill level of only containers of that type), and/or S100 can include receiving multiple training sets (e.g., wherein each training set includes images of a single type of container, preferably a different type than for the other training sets). The images for a given container preferably include images of the container in different states of fill, more preferably including various fill levels between 0 (e.g., unfilled) and 100% (e.g., filled).

In embodiments in which a container is associated with multiple cameras, the images are preferably grouped by container. All images of an image group are preferably images captured substantially concurrently (e.g., simultaneously, within a threshold time of each other, with substantially no change in container content between the image captures, etc.), but can alternatively be captured with any other suitable timing relative to each other. Each image of an image group is preferably associated with a different camera of the container (e.g., associated with a camera ID for that camera).

Although reference may be made to a single image, a person of skill in the art will recognize that the method can be performed using image groups rather than individual images (e.g., in embodiments in which multiple cameras are associated with a container).

The training set can optionally include data sampled by one or more auxiliary sensors of the imaging device (“auxiliary data”), such as sensors described above regarding the system 20. The auxiliary data is preferably sampled substantially concurrent with the sampling time of the image (or image group) with which it is associated (e.g., simultaneously, within a threshold time of the image sampling time, with substantially no change in container content between the image sampling and auxiliary data sampling, etc.). The auxiliary data can additionally or alternatively include a time series of data (e.g., associated with an indication of the image sampling time relative to the time series, preferably wherein the time series overlaps the image sampling time) and/or data sampled with any other suitable timing. However, the training set can additionally or alternatively include any other suitable data types.

The training set is preferably a labeled set (e.g., wherein each image is associated with a known fill level). The fill level (e.g., fullness metric) preferably represents an occupied fraction of container storage volume (e.g., wherein an empty container has a fill level of 0% and a completely full container has a fill level of 100%). The fill level does not necessarily represent a uniform level of container filling (e.g., wherein a tall mound of contents within a corner of the container may represent the same fill level as a shallow layer of contents spread uniformly across the container floor, despite reaching a much higher maximum height). In one example, the known fill levels can be determined by providing the images to human classifiers and using their fill level determinations as the known fill level. In another example, an image associated with a predetermined condition can be associated with a predetermined fill level (e.g., 100% when the upper container edge cannot be detected in the image, 100% when the container lid consistently fails to close, 0% after sampling accelerometer data associated with emptying the container, etc.).

The fill level can additionally or alternatively represent any other suitable type of fill level, such as an occupied fraction of container storage area (e.g., floorspace coverage, wherein an empty container has a fill level of 0% and a container whose entire floor is covered by contents has a fill level of 100%, whether or not additional unfilled volume remains in the container; wall coverage, such as representing accessibility and/or usage of tie-downs, wall-mounted shelving, and/or any other suitable elements; etc.). In one example, a right cuboidal container interior contains a single right cuboidal object (or analogously, a stack of multiple objects, wherein the stack defines a substantially right cuboidal shape), wherein the container interior is 4 meters tall with a 10 square meter floor, and the object has dimensions of 1×2×4 meters, corresponding to a volumetric fullness metric of 20%. In this example, if the object is placed in the container with a 2×4 meter face on the floor, so that it is 1 meter tall, the floorspace coverage metric is 80%; if it is placed with a 1×4 meter face on the floor, so that it is 2 meters tall, the floorspace coverage metric is 40%; and if it is placed with a 1×2 meter face on the floor, so that it is 4 meters tall, the floorspace coverage metric is 20%. However, the training set can be labeled in any other suitable manner.

In some embodiments the training set includes a first training set (e.g., for use in S200) and a second training set (e.g., for use in S300). The first and second set are preferably disjoint (e.g., wherein the first and second set are complementary) but can alternatively be overlapping. However, the training set can additionally or alternatively include any other suitable subsets.

The training set can be received all at once, received over time, received throughout performance of the method, and/or received with any other suitable timing. For example, the method can optionally include continuing to receive training images during, and/or after performance of other elements of the method, such as S200, S300, and/or S400.

S100 can additionally or alternatively include receiving an additional training set, which preferably functions to provide a set of input data for training a diverter model (e.g., unsuitable label determination model). The additional training set can be analogous to that described above regarding the training set for training the fullness model (e.g., can be the same training set as described above, can have similar or identical aspects to those described above, etc.), but can additionally or alternatively include any other suitable training data.

Each image in the additional training set can be associated with information indicative of the image's suitability for use as an input to the fullness model (e.g., labeled with labels such as a candidate label or an unsuitable label, labeled with a suitability score, an unsuitability score, and/or a score associated with one or more unsuitable conditions, etc.). The suitable images (e.g., images labelled with a candidate label, with high suitability scores, and/or with low unsuitability scores, etc.) can include: images depicting a container interior, images captured by a content sensor that is not obscured (e.g., the content sensor is not covered by a box, the content sensor includes a clean lens, and/or the content sensor is otherwise not blocked), and/or any other suitable image depicting a container interior. The unsuitable images (e.g., images labelled with an unsuitable label) and/or the reason for unsuitability can include: images captured by a content sensor experiencing a malfunction, images captured by a content sensor that is obscured (e.g., the content sensor is covered by a box, the content sensor includes a dirty lens, and/or the content sensor is otherwise blocked), images captured by a content sensor wherein the content sensor field-of-view does not depict a container interior, and/or any other unsuitable images captured by the content sensor.

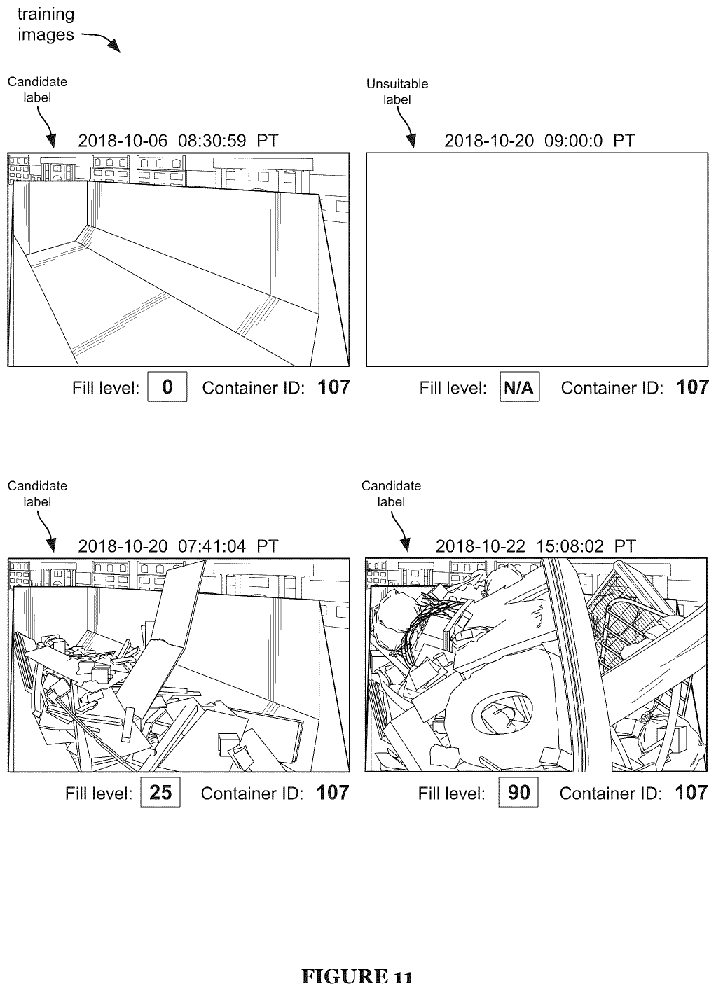

The candidate model label can be a value (e.g., fill level, a binary value such as to indicate the image is associated with a candidate label, etc.), can be alphabetic (e.g., “candidate”, “yes”, etc.), and/or can be any other suitable label. The unsuitable label can be a value (e.g., binary value, such as to indicate the image is associated with an unsuitable label; integers mapped to different unsuitable label reasons, such as a 2 mapped to unsuitable reason 2, 3 mapped to unsuitable reason 3, etc.), can be alphabetic (e.g., “N/A”, the unsuitable label reason, “no”, etc.), and/or can include any other suitable label(s). Examples of candidate labelled images and unsuitable labelled images are depicted in FIG. 11. However, the additional training set can additionally or alternatively be labeled in any other suitable manner.

In some embodiments, S100 includes receiving a first training set associated with fill level determination (e.g., labeled with known fill levels) and receiving a second training set associated with unsuitable image determination (e.g., images labeled with candidate labels and/or unsuitable labels), wherein the training sets can be partially overlapping sets, disjoint sets, sets having a subset-superset relationship, and/or sets with any other suitable relationship. In other embodiment, S100 includes receiving a single training set associated with both fill level determination and unsuitable image determination.

However, S100 can additionally or alternatively include receiving any other suitable training set in any suitable manner.

### 3.2 Training a Neural Network

Training a neural network S200 preferably functions to train a model (e.g., trained neural network) for determining the container fill level based on container images. Training a neural network preferably includes optimizing a set of weight values associated with each node of the neural network (or a subset thereof), wherein each layer of the neural network preferably includes a plurality of nodes. S200 preferably includes performing supervised learning using a training set (e.g., the training set received in S100 or a subset thereof, such as the first training set), but can additionally or alternatively include performing unsupervised learning (e.g., using clustering algorithms, deep neural network clustering techniques such as Deep Cluster, recurrent neural networks, and/or other recurrent algorithms, etc.), and/or training the neural network in any other suitable manner. As a person skilled in the art would recognize, although referred to herein as a “neural network”, S200 need not be limited to training a neural network, but rather can additionally or alternatively include training any other suitable classifier (e.g., linear classifiers such as logistic regression, Fisher's linear discriminant, Naïve Bayes classifier, perceptron, etc.; support vector machines such as least squares support vector machines; quadratic classifiers; kernel estimation classifiers such as k-nearest neighbors; boosting; decision trees such as random forests; learning vector quantization; etc.), and/or any other suitable model to perform the specified functionalities; accordingly, such a classifier can be employed in performance of other elements of the method 10 (e.g., in place of the “neural network”).

In some embodiments, the neural network includes (e.g., is) a recurrent neural network, such as a recurrent neural network that is trained on historical (e.g., timestamped) series of images to determine the fill level of a container.

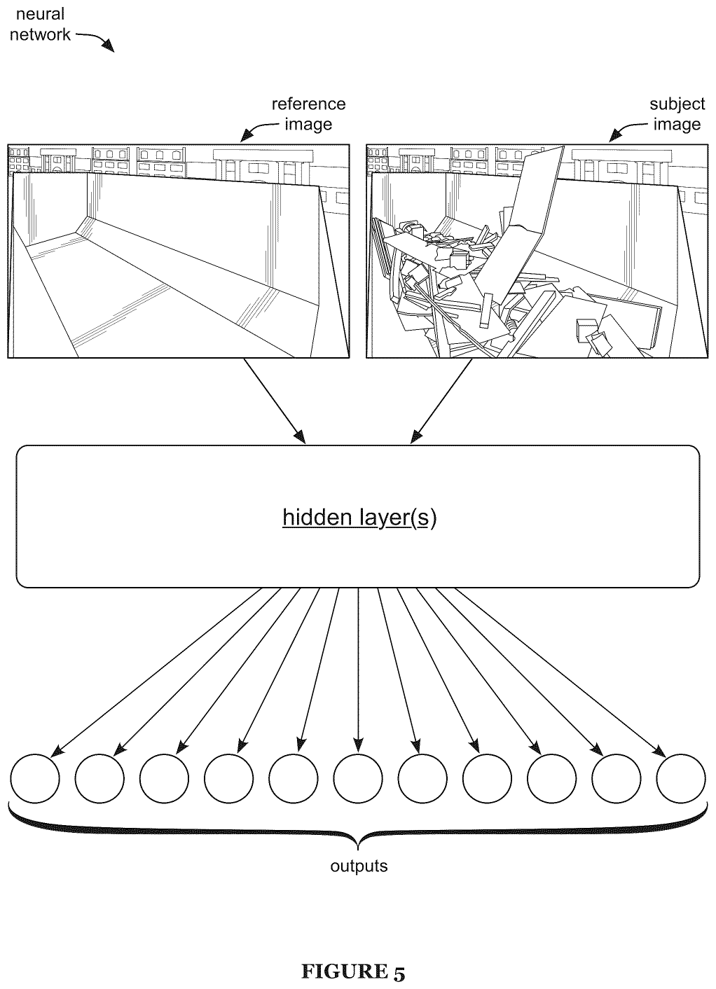

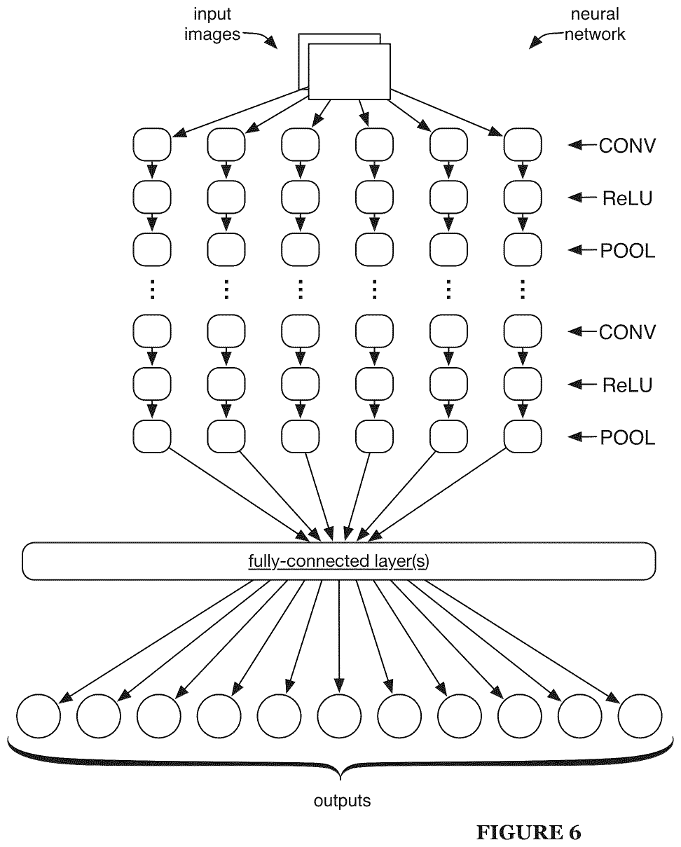

The neural network is preferably trained using a subject image (e.g., the image to be assessed) and a reference image (e.g., as shown in FIG. 5). The reference image is preferably an image sampled by the same camera as the subject image (e.g., an image of the same container from the same viewpoint, such as shown by way of examples in FIGS. 4A, 4B, 5, 8, and/or 14A-14B), but the reference image can additionally or alternatively be sampled by a different camera (e.g., an image of the same container from substantially the same viewpoint, such as ±10 degrees difference from the subject image, ±20 degrees, etc.; an image of a different container from substantially the same viewpoint, such as an image of a substantially identical container and/or a container of the same type, model, shape, dimensions, and/or any other suitable container characteristics, etc.; and/or any other suitable reference image). The reference image is preferably associated with a known fill level (e.g., human-determined fill level, automatically determined fill level, etc.). Preferably, all reference images used with the neural network have a substantially equal fill level (e.g., within a threshold distance, such as ±5%, ±10%, in the range 0-15%, etc., of a target fill level), more preferably all being images of substantially empty containers (e.g., fill level less than a threshold such as 5%, 10%, 0-15%, 0-20%, etc.). However, the reference images can additionally or alternatively include images of containers of any other suitable fill levels. In alternate embodiments (e.g., in which the fill level of each reference image is known, but is not substantially equal between different reference images), the reference image can be input to the neural network in association with its (known) fill level. The reference image is preferably selected as described below (e.g., regarding S300), but can additionally or alternatively be selected in any other suitable manner.

The subject image and/or reference image (preferably both images) can be grayscale images, color images (e.g., wherein the red, green, and blue channels are provided as three separate inputs to the neural network), and/or images of any other suitable type. The images can additionally or alternatively be pre-processed (e.g., to normalize brightness and/or contrast, crop, align, undistort, etc.). In some embodiments, the subject image and/or reference image is an image group (e.g., stereoscopic image pair, images captured from opposing ends of a container, etc.) rather than a single image. In some embodiments, the neural network additionally or alternatively accepts auxiliary data as an input. However, the neural network can additionally or alternatively accept any other suitable inputs.

The neural network preferably accepts the multiple images (e.g., subject image and reference image, multiple images from each image group, etc.) as inputs. The images are preferably stacked (e.g., along a depth dimension orthogonal to the image spatial dimensions, analogous to the stacking of different color channels in a typical convolutional neural network), but can additionally or alternatively be concatenated (e.g., along one or more image spatial dimensions), provided as separate inputs (e.g., wherein the neural network includes a separate branch for each image) which are combined at a downstream layer or layers (e.g., using a fully connected layer, concatenation layer, etc.), and/or input in any other suitable manner. However, the inputs can additionally or alternatively be provided in any other suitable manner.

The neural network is preferably a convolutional neural network (CNN), but can additionally or alternatively include (e.g., be) a fully connected neural network, a V-NET, a Siamese network, and/or any other suitable network. The CNN preferably includes an assortment of one or more of convolutional (CONV) layers, pooling (POOL) layers (e.g., max pooling layers), activation layers (e.g., rectified linear unit (ReLU)), fully-connected layers, and/or any other suitable layers. In one example, the CNN includes a series of convolutional layers, optionally including pooling and/or activation (e.g., ReLU) layers after some or all convolutional layers, and one or more fully connected layers (e.g., as shown in FIG. 6). However, the CNN can additionally or alternatively have any other suitable structure.

The neural network preferably provides multiple output values, each corresponding to a different fill level (e.g., fill level range or bucket). The fill levels are preferably evenly spaced (e.g., over the entire possible range between 0 and 100%), such as spaced every 1%, 2%, 5%, or 10%. In one example, the CNN includes 21 outputs, each corresponding to a different bucket between 0 and 100% (e.g., spaced every 5%). Alternatively, the fill levels can be spaced unevenly, have logarithmic spacing, and/or have any other suitable spacing.

Preferably, each output represents a likelihood of and/or confidence in the corresponding fill level (e.g., the output values sum to 1). For example, the outputs can be the outputs of a softmax classifier. Alternatively, the output values can be arbitrary, such as output values of an SVM classifier and/or any other suitable classifier. In an alternate embodiment, the neural network has a single output (e.g., regression output, wherein the output value represents the fill level). However, the neural network can additionally or alternatively include any other suitable outputs.

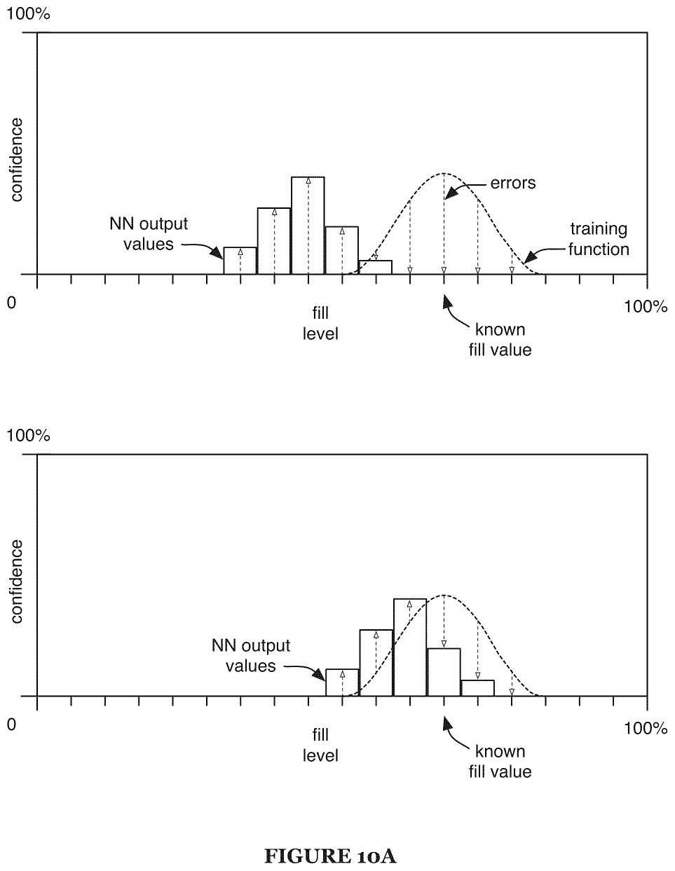

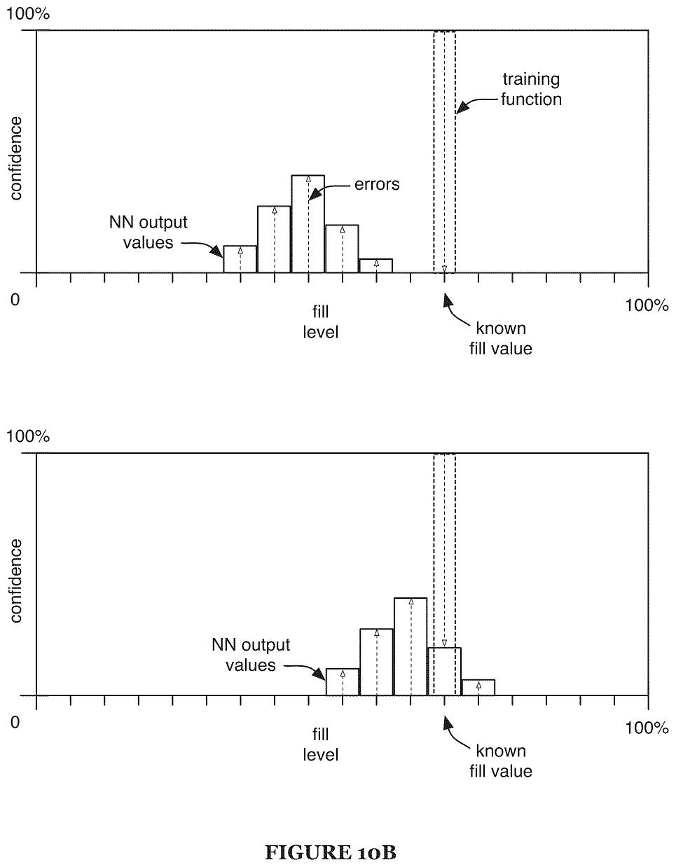

The loss function for training the neural network preferably includes a lower penalty for outputs close to the true fill level (e.g., and zero penalty for outputs at the correct fill level), such as a penalty which is an increasing function of distance to the true fill level (e.g., penalty calculated based on errors between the neural network output values and a training function, such as shown by way of example in FIG. 10A). For example, the training function and/or penalty function can be a linear function, quadratic function, root function, based on a statistical distribution function centered on the true value (e.g., a Gaussian distribution, Johnson distribution, etc.), such as a training function equal to the statistical distribution and/or a penalty function equal to one minus the statistical distribution, and/or any other suitable function.

Additionally or alternatively, the loss function can penalize incorrect outputs based on a rewards matrix. The loss function can receive the rewards matrix as an input (and/or can receive the matrix in any other suitable manner). The rewards matrix preferably defines penalties for incorrect outputs (e.g., wherein errors of different types and/or severities can be penalized differently, such as based on costs and/or other undesirable consequences resulting from occurrence of the error). Each entry of the rewards matrix is preferably determined based on (e.g., is a function of, such as a function including addition, subtraction, multiplication, exponentiation, and/or any suitable operations, etc.) the output and/or the associated label (e.g., the true fullness metric), and can additionally or alternatively be determined based on: a weight value corresponding to the output, a weight value corresponding to the true fullness metric, and/or any other suitable values or weights. In one example, errors associated with low fullness metrics (e.g., wherein the model-predicted and/or true fullness metric less than a threshold value, such as 5, 10, 15, 20, 25, 30, 0-10, 10-20, or 20-30%, etc.) can be penalized more heavily than errors not associated with low fullness metrics; in this example the rewards matrix is preferably designed to penalize the outputs of the neural network accordingly. For example, a first situation, in which the model determines that the fullness metric is 30% when the true fullness metric is 0%, can be considered worse than a second situation, in which the model determines that the fullness metric is 60% when the true fullness metric is 30% (e.g., even though the absolute difference between the model determination and the true fullness metric is the same for both situations).

Alternatively, all incorrect outputs can be penalized equally (e.g., as shown in FIG. 10B), such as in a 1-hot training approach. The neural network can be trained using any suitable training technique(s).

S200 can additionally or alternatively include training the diverter model (e.g., unsuitable label determination model), which can function to train a model for determining an image depicting a suitable container interior (e.g., determine whether an image depicts a suitable container interior, score images based on suitability, etc). The model is preferably trained using the training data received in S100 (e.g., using the additional training set described above, using images and/or other information from the training set for the fullness model, etc.), but can additionally or alternatively be trained using any other suitable data.

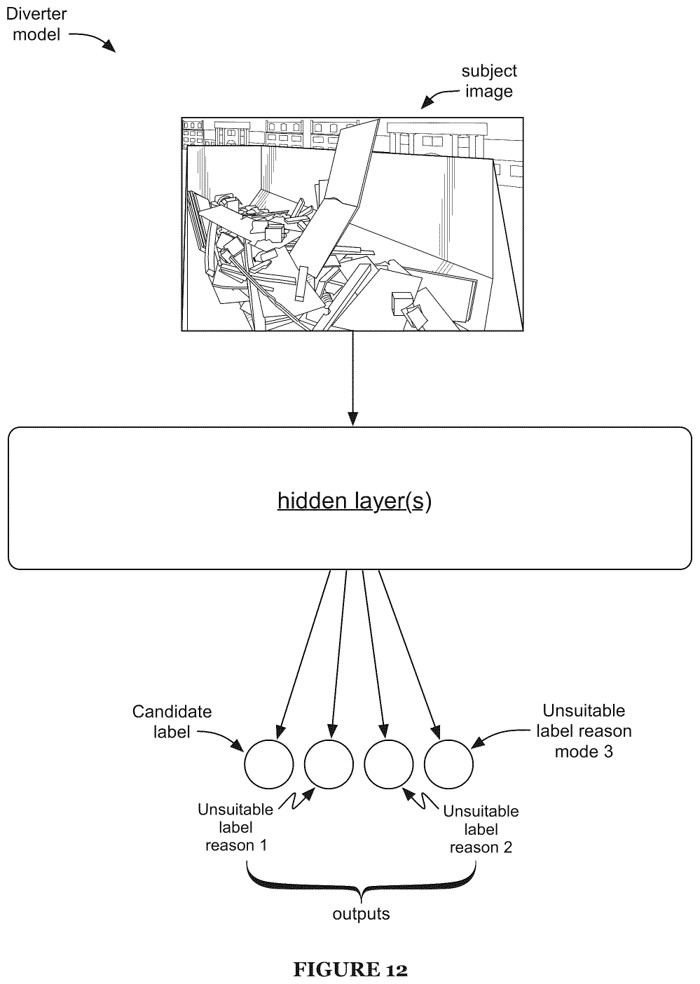

The diverter model preferably accepts a single image input, such as depicted in FIG. 12, but can additionally or alternatively accept inputs including multiple images, auxiliary sensor data (e.g., ultrasound data, TOF sensor data, etc.), and/or any other suitable data or information (e.g., in addition to and/or in place of image data).

The input image for the diverter model (“diverter model subject image”) can have some or all characteristics (e.g., dimension, image type, brightness, contrast, color mode, etc.) in common with the subject image for the fullness model, and/or can differ from the fullness model subject image in any suitable manner. For example, the subject images can be the same image, one can be a derivative (e.g., cropped, interpolated, scaled, blurred, having altered pixel characteristics such as brightness, contrast, color, etc.) of the other, or the subject images can both be derivatives of a parent image. However, the subject images can additionally or alternatively be otherwise related, or can be unrelated. The diverter model subject image can be a grayscale image, color image (e.g., wherein the red, green, and blue channels are provided as three separate inputs to the neural network), and/or an image of any other suitable type. The image can additionally or alternatively be pre-processed (e.g., to normalize brightness and/or contrast, crop, align, undistort, etc.). In some embodiments, the subject image is an image group (e.g., stereoscopic image pair, images captured from opposing ends of a container, etc.) rather than a single image. In some embodiments, the neural network additionally or alternatively accepts auxiliary data as an input. However, the diverter model can additionally or alternatively accept any other suitable inputs.

The diverter model preferably includes a neural network, such as a network including one or more layers such as described above with respect to the fullness model (e.g., including one or more aspects in common with and/or similar to the fullness model, including aspects associated with alternative elements of the fullness model described above, etc.), but can additionally or alternatively include neural networks of any other suitable structure, and/or can include any other suitable model elements.

The diverter model preferably provides multiple output values, each preferably corresponding to a different label (e.g., candidate label, unsuitable label, unsuitable label reason, etc.), such as depicted by way of example in FIG. 12. In a first example, the CNN includes 4 outputs, each corresponding to a different label, such as a candidate label and three unsuitable label reasons. In a second example, the CNN includes 2 outputs, the first corresponding to a candidate label and the second corresponding to an unsuitable label.

Preferably, each output represents a likelihood of and/or confidence in the corresponding candidate label and/or unsuitable label. In one such example, the outputs can be the outputs of a softmax classifier. In a second such example, the diverter model has a single output (e.g., regression output, wherein the output value represents the probability that the image is associated with a candidate label). Alternatively, the diverter model can provide a classification without such corresponding information. For example, the diverter model can include a one-hot output indicating the classification. However, the diverter model can additionally or alternatively include any other suitable outputs.

The loss function for training the diverter model can be a classification loss function, such as cross entropy loss or hinge loss (multi-class SVM loss), but can additionally or alternatively be any other suitable loss function.

However, the diverter model can additionally or alternatively be otherwise trained, and/or can additionally or alternatively include any other suitable elements.

### 3.3 Selecting References

Selecting reference images S300 preferably functions to select a reference image of each container (e.g., of the substantially empty container). S300 can optionally include determining the target fill level for the reference images. The target fill level is preferably zero, but can alternatively be any other suitable value (e.g., between 0 and 100%).

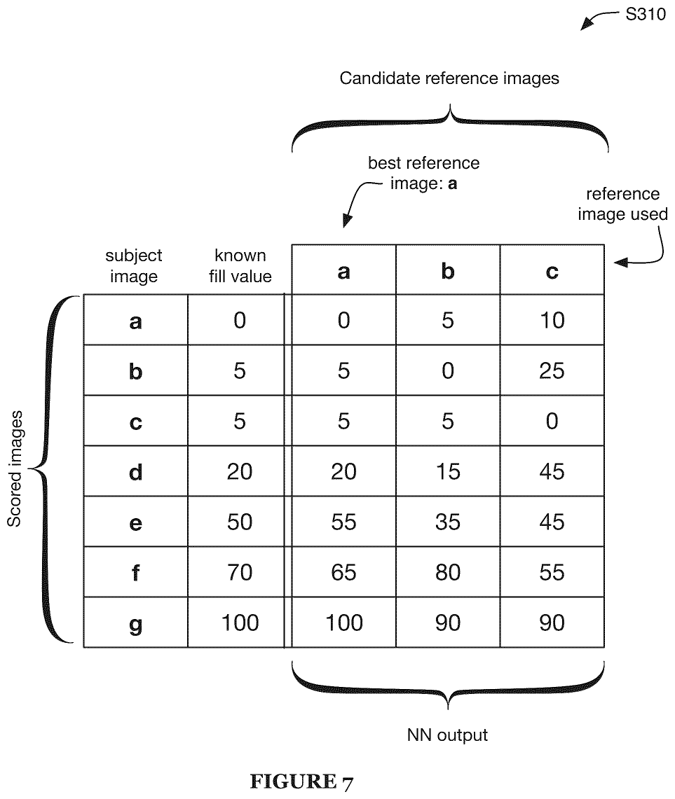

S300 includes selecting a reference image of a container S310 (e.g., as shown in FIG. 7). S310 is preferably performed for each container, but can alternatively be performed for a subset of containers (e.g., each type of container) and/or for any other suitable containers. The reference image S300 is preferably an image sampled by the content sensor mounted to the subject container (the container for which the reference image is selected), but can alternatively be any other suitable image.

For a particular container, S310 preferably includes considering the set of scored images (or image groups) of the container. A scored image is preferably an image for which the true fill level is known, but can additionally or alternatively be an image for which a scored fill level distribution (e.g., associated with estimate(s) of the fill level) is known, and/or can be an image associated with any other suitable fill level label. Estimating the fill level can include evaluating the average of the scored distribution, evaluating the weighted average of the scored distribution, and/or otherwise estimating the fill level. The set of scored images preferably includes only images for which the fill level was determined by one or more humans, but can additionally or alternatively include images associated only with computer-determined fill levels (e.g., determinations made using sensor fusion, determinations made auxiliary sensor signals, determinations made image analysis such as by a neural network, etc.) and/or images associated with fill levels determined in any other suitable manner.

In some embodiments, S310 can include receiving a batch of images (e.g., wherein some or all images of the batch are associated with the same subject container identifier, not associated with the same subject container identifier, and/or not associated with any container identifier). Receiving a batch of images can additionally include receiving a set of scores associated with some or all images of the batch (e.g., defining a set of scored images). The set of scored images can be used to evaluate a set of candidate reference images, wherein the set of candidate reference images can be a subset of the batch of images, and/or any other suitable candidate reference image set.

S310 can include selecting a subset of the scored images for which the known fill level is within a threshold distance of the target fill level. This preferably includes selecting all such images for which this criterion is satisfied, but can alternatively include selecting any suitable subset thereof. For a target fill level of zero (empty), this can include selecting all images for which the known fill level is less than a threshold amount (e.g., the threshold distance, such as described above regarding S200).

S310 preferably includes, for each image of the subset, using the trained neural network to determine fill levels for all images of the set of scored images (e.g., as described below in S400, preferably without using an alternative technique for uncertain outputs), wherein the respective image of the subset is used as the reference image.

The image for which the trained neural network performed best (e.g., closest to the known fill level values) is preferably selected as the reference image. Neural network performance is preferably determined based on the difference between fill level determinations (e.g., between the known fill level and the fill level determined by the trained neural network) of one or more images. For example, the performance can be determined based on the average difference, median difference, maximum difference, difference at a predetermined percentile, and/or difference metric associated with any other suitable image or set of images. The performance can additionally or alternatively be determined based on the uncertainty associated with the determinations (e.g., wherein low uncertainty for correct or nearly-correct assessments represents superior performance, wherein high uncertainty for incorrect assessments represents superior performance, etc.). However, neural network performance can additionally or alternatively be determined based on any other suitable criteria.

Alternatively, S310 can include selecting the image (or image group) with the lowest known fill value, selecting a random image (or image group) from the set of images with sufficiently low fill value (e.g., fill value below the threshold), selecting the most recently captured scored image with a sufficiently low value, and/or selecting any other suitable reference image.

However, S300 can additionally or alternatively include selecting the reference images in any other suitable manner.

### 3.4 Determining Container Fill Level

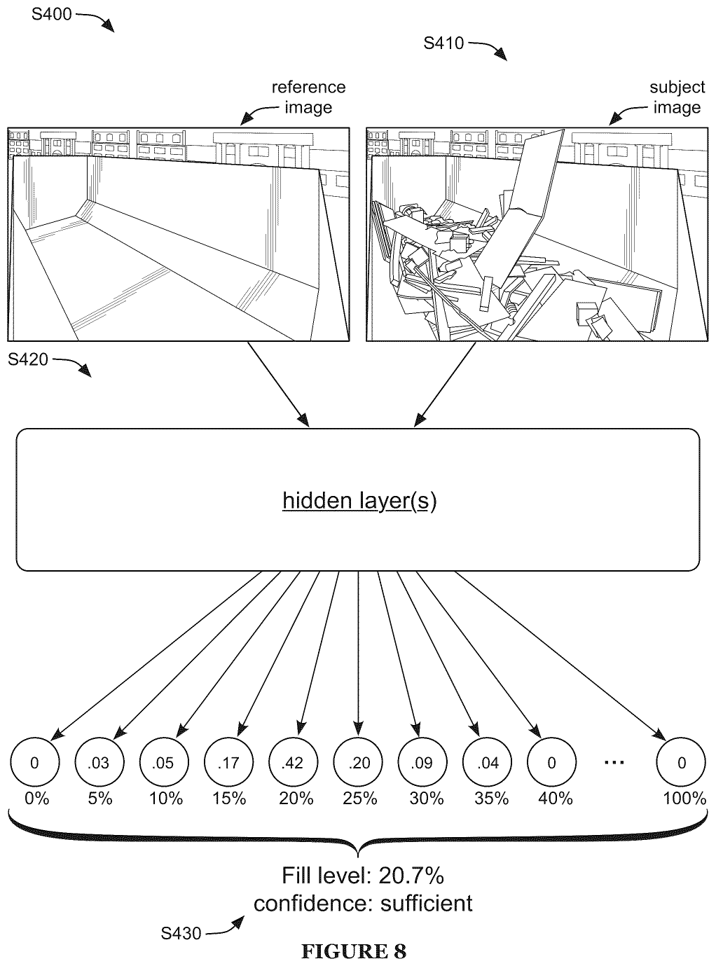

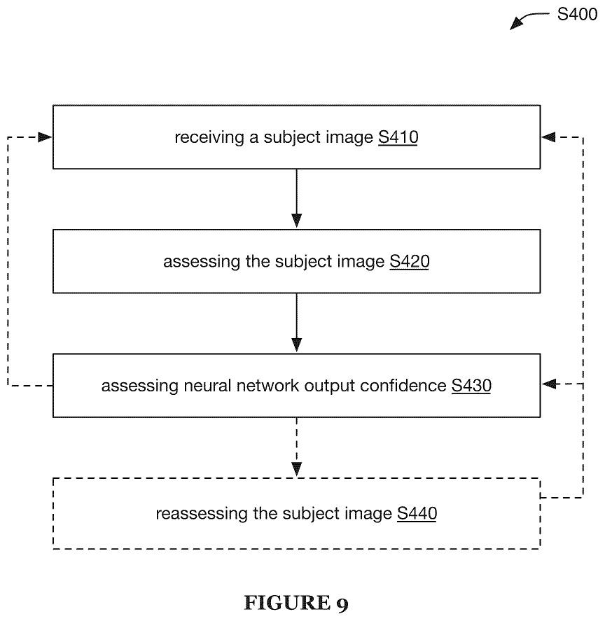

Determining a container fill level S400 preferably functions to assess images with unknown fill levels (e.g., as shown in FIG. 8). S400 preferably includes receiving a subject image S410, assessing the subject image using the trained neural network S420, and/or assessing the confidence of the neural network output S430, and can optionally include reassessing the subject image S440 (e.g., as shown in FIG. 9). However, S400 can additionally or alternatively include any other suitable elements.

S400 can be performed for any suitable set of images. In a first example, S400 is performed for each image captured by an imaging device (e.g., mounted to the subject container). In a second example, S400 is performed for each substantially unique image (e.g., having at least a threshold difference from previously-captured images). In a third example, S400 is performed with a predetermined frequency (e.g., performed for a threshold number of images, such as 1, 2, 3, 4, 5, 10, 20, 50, 1-5, 5-20, or 20-100 images, in a time interval, such as a minute, hour, day, week, month, or year; performed for a threshold subset of images, such as once for every 2, 3, 4, 5, 10, 20, 50, 2-5, 5-20, or 20-100 images captured; etc.). In a fourth example, S400 is performed in response to one or more triggers (e.g., user request to assess an image, auxiliary sensor data indicative of a trigger event, etc.). However, S400 can additionally or alternatively be performed for any other suitable set of images and/or with any other suitable timing.

S410 preferably includes receiving an image (or image group) of a container (e.g., received in association with the container ID). The image is preferably an image such as described above (e.g., regarding S100), but can additionally or alternatively be any other suitable image. The image can be received from an imaging device (e.g., transmitted by the imaging device upon capture, in response to data connection availability, etc.), received from storage (e.g., from a database of a computing system, such as the remote server), received from a user (e.g., uploaded by the user in order to be assessed), received from the diverter model, and/or received from any other suitable entity.

In some embodiments, S410 is performed for one or more containers (e.g., includes receiving images of the one or more containers), such as containers represented in the training set and/or containers not represented in the training set. However, S410 can additionally or alternatively include receiving any other suitable images in any suitable manner.

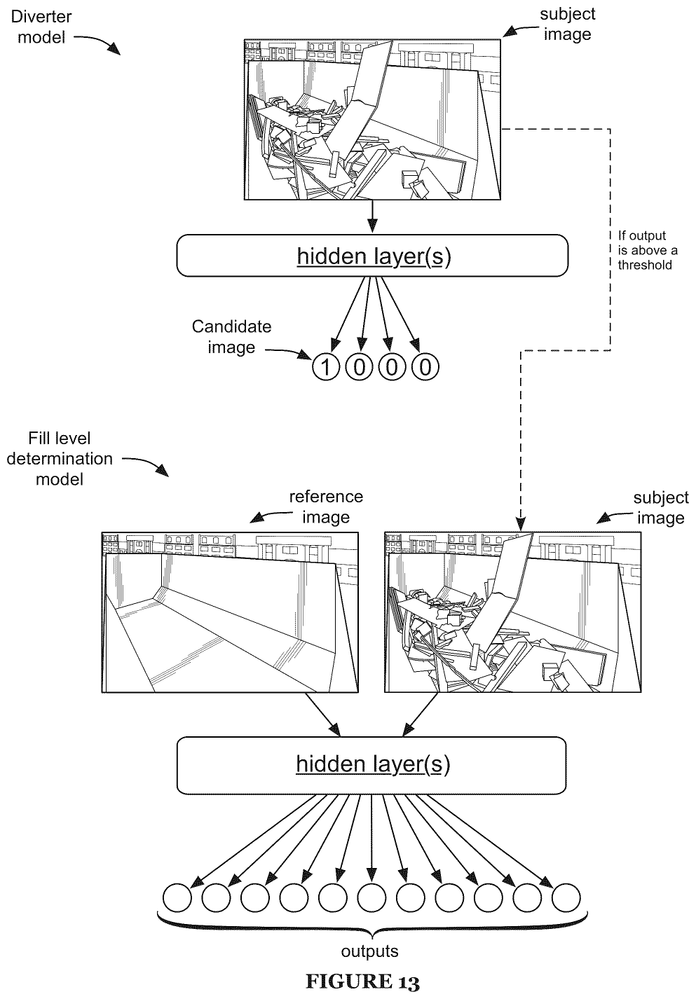

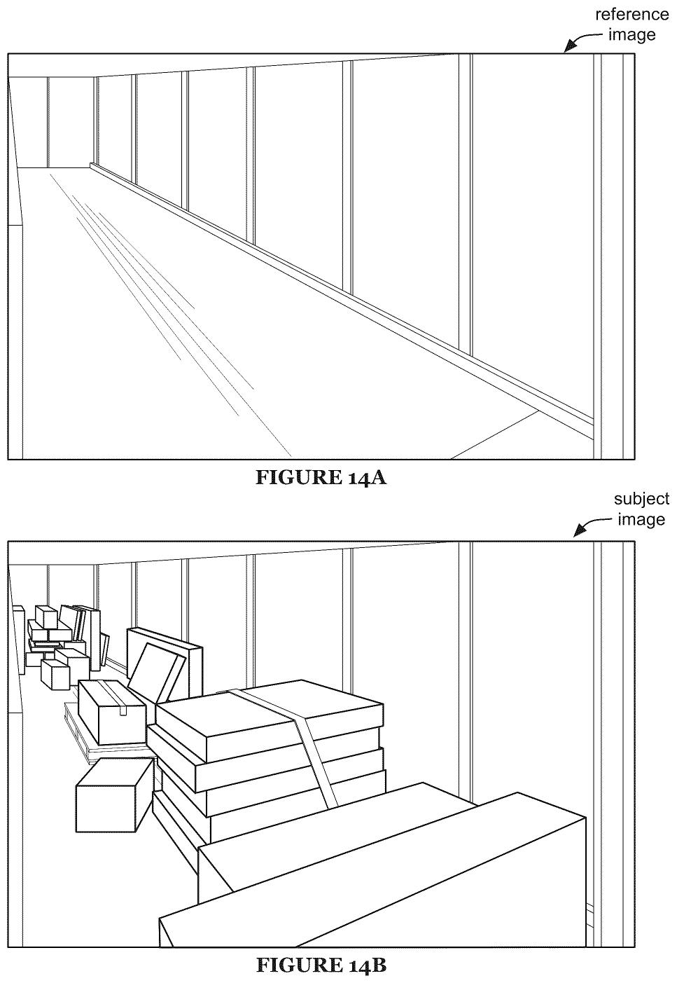

In some embodiments, receiving the subject image can include processing the subject image using the diverter model (e.g., to determine if the image depicts a suitable container interior). In such embodiments, the image can be selectively served or not served to the fullness model based on the output of the diverter model. For example, images determined (e.g., by the diverter model) to be candidate images and/or to have a likelihood of being a candidate image greater than a threshold (e.g., 30%, 50%, 80%, 90%, 95%, 99%, less than 30%, 30-50%, 50-80%, 80-95%, 95-99%, 99-100%, etc.) can be provided as input to the fullness model, whereas other images (e.g., determined to be unsuitable, likely to be unsuitable, probability of being unsuitable greater than a threshold, etc.) can be not provided as input (e.g., can be discarded, can be directed for alternate analysis such as human analysis, etc.), such as shown by way of example in FIG. 13. However, S400 can additionally or alternatively include combining (e.g., chaining) the diverter model and fullness model in any other suitable manner, or can include not combining the models.

S420 preferably includes determining the associated reference image (or image group) for the subject image. The reference image is preferably determined based on the associated container (e.g., based on the container ID), but can additionally or alternatively be determined in any other suitable manner. The same reference image can be used for a given container for each performance of S400. Alternatively, different reference images can be determined and/or used: each time the container is emptied, after (e.g., in response to) receipt of additional training data (e.g., used to updated the neural network training), at a predetermined frequency, and/or with any other suitable timing. S420 preferably includes inputting the subject and reference images into the trained neural network, and determining the fill level of the subject image based on the neural network output.

In some embodiments, the fill level is determined as the weighted average of the outputs (e.g., the average of the fill levels associated with each output, wherein each fill level is weighted by its respective output value (likelihood)). Alternatively, determining the fill level can include assuming a statistical distribution of the outputs (e.g., Gaussian distribution, semi or fully bounded Johnson distribution, etc.), wherein the fill level is determined based on a maximum likelihood estimation using the assumed distribution.

In some embodiments, outputs near the fill level bounds (e.g., 0 and/or 100%) can be handled as special cases. In a first example, when the determination (e.g., based on the weighted average) is within a threshold distance (e.g., 2%, 5%, 10%, 15%, 0-5%, 5-15%, etc.) of a bound, the determination can be set equal to a default value (e.g., the boundary value). For example, a weighted average above 90% can be set to a default value of 100% and a weighted average below 10% can be set to a default value of 0. In a second example, a maximum likelihood estimation can be performed, preferably using a semi-bounded (or fully-bounded) distribution (e.g., semi-bounded Johnson distribution, such as a log-normal distribution). However, S420 can additionally or alternatively include assessing the subject image in any other suitable manner.

Assessing confidence of the neural network output S430 preferably includes determining a metric associated with spread of the outputs. In examples, the spread metric can include the range, interquartile range, variance, standard deviation, density within a threshold band, and/or any other suitable metric. In a specific example, the metric is the sum of outputs within a threshold distance from the determined fill level (e.g., within 5%, 10%, 15%, 20%, etc.). If the spread metric is beyond a threshold spread value (e.g., the outputs exhibit more spread than the threshold), the neural network output confidence is low. For example, if less than a threshold sum falls within the threshold distance of the determined fill level (e.g., less than 50% of the output value is within plus or minus 15% of the value determined in S420), the confidence is determined to be low.

In response to determining that the neural network confidence is low, S400 preferably includes reassessing the subject image (e.g., as described below regarding S440). Alternatively, if the neural network output confidence is determined to be sufficient (e.g., if the spread of the neural network outputs is less than the spread threshold), the value determined in S420 is preferably used (e.g., preferably stored in association with the image). However, S430 can additionally or alternatively include assessing confidence of the neural network output in any other suitable manner.

Reassessing the subject image S440 can function to determine the fill level with additional certainty. The subject image is preferably reassessed using a different assessment technique than used in S420. For example, the subject image can be assessed using a human classifier (or set of multiple humans, such as operating on a consensus basis), assessed using a different neural network than the trained neural network, and/or reassessed in any other suitable manner. S440 is preferably performed for images for which the neural network outputs exhibit low confidence (e.g., as described above regarding S430). S440 can additionally or alternatively be performed for randomly selected images (e.g., a predetermined fraction of all images assessed in S420) and/or any other suitable images. Images reassessed in S440 are preferably added to a training set (e.g., the training set received as described above regarding S100), in association with the fill value determined in S440, such as for future performance of other elements of the method (e.g., such as S200 and/or S300).

However, S400 can additionally or alternatively include determining the container fill level in any other suitable manner.

### 3.5 Container State Changes

In some embodiments, the method can include determining information associated with container state changes (e.g., contents addition and/or removal), preferably based on the fill level(s) of the container (e.g., determined as described above, such as regarding S400). For example, the method can include determining (e.g., detecting, confirming, etc.) whether a container service event (e.g., dumpster unloading event) occurred for a particular container.

Determining whether the container service event occurred S900 can be performed in response to a trigger (e.g., auxiliary data and/or user input indicative of potential container servicing), based on a container service schedule (e.g., schedule assigned to a container service provider, such as a predetermined schedule), periodically, and/or with any other suitable timing. In a first example, a person associated with container servicing (e.g., a container service provider) provides an input (e.g., via a client of a user device such as a smartphone, via a dedicated hardware input, via communication with a remote computing system, etc.) indicating that a container service event was performed for a particular container (preferably providing the input during and/or after performing a container service event for the container, such as emptying a dumpster), wherein S900 is performed in response to receiving the input. In a second example, S900 is performed in response to accelerometer data indicative of a potential container service event (e.g., classified as such based on heuristics, models such as random forest classifiers, etc.). In a third example, S900 is performed after a container service event is due for the container (e.g., based on the service schedule). However, S900 can additionally or alternatively be performed with any other suitable timing.

S900 preferably includes comparing the container fill level at various points in time (e.g., before and after the suspected and/or purported service event, throughout a time series encompassing the suspected and/or purported service event, etc.). For example, the fill level of an image captured after the trigger event (e.g., the next image captured, image captured within a threshold time period such as 1 min, 10 min, 1 hr, etc.) can be compared to the fill level of an image captured before the trigger event (e.g., the most recent previously-captured image, image captured within a threshold time period such as 1 min, 10 min, 1 hr, etc.). The fill levels are preferably determined as described above, but can additionally or alternatively be determined in any other suitable manner.

A rapid reduction (e.g., occurring within a threshold time period, such as less than 10 s, 20 s, 1 min, 5 min, 20 min, 10-60 s, 1-10 min, 10-100 min, etc.) and/or significant reduction (e.g., more than a threshold fill level change, such as 5%, 10%, 15%, 25%, 50%, 80%, 95%, 0-5%, 5-20%, 20-50%, 50-80%, 80-100%, etc.; reduction to less than a threshold final fill level, such as 20%, 15%, 10%, 5%, 2%, 1%, 0-5%, 5-15%, 15-30%, etc.) in container fill level can be indicative of service event occurrence, whereas the lack of such a reduction can be indicative of the absence of any service event. In response to determining whether a container service event occurred, the analyzed images (and/or auxiliary data) can optionally be stored (e.g., in association with data indicative of the trigger), provided to users of the system (e.g., customer and/or service provider associated with the container), and/or used in any other suitable manner.

### 3.6 Contamination Assessment

In some embodiments, the method 10 (and/or elements thereof, such as determining a container fill level S400) can be applied as part of one or more methods for contamination assessment. For example, the method for contamination assessment described in U.S. patent application Ser. No. 17/145,021, filed 08 Jan. 2021 and titled “Method and System for Contamination Assessment”, which is herein incorporated in its entirety by this reference, can include performance of one or more elements described herein regarding the method 10; for example, ‘sorting the images S200’ of U.S. patent application Ser. No. 17/145,021 can include determining the fill level of one or more images (e.g., all images to be sorted, or a subset thereof) such as described herein (e.g., described herein regarding S400 and/or associated elements of the method 10). In one example, in which a classifier (e.g., neural network or other statistical classifier, such as described above in more detail) is configured (e.g., has been trained) to determine fill levels as described above, a reference image for the relevant container is selected (e.g., as described above, such as regarding S300), and, for each image to be sorted (or a subset thereof), the image to be sorted and the reference image are provided to the classifier as input, wherein the classifier determines the fill level of the image to be sorted based on the input. For example, the classifier can be a convolutional neural network that accepts an input including both the reference image and the image to be sorted, wherein the two images are stacked along a depth dimension orthogonal to the image spatial dimensions (e.g., as described above in more detail); however, the classifier can additionally or alternatively have any other suitable characteristics and/or can accept the input in any other suitable format.

Additionally or alternatively, the method for contamination assessment described in U.S. patent application Ser. No. 17/145,021 can be performed independent from any or all aspects described herein regarding the method 10. For example, ‘sorting the images S200’ of U.S. patent application Ser. No. 17/145,021 can additionally or alternatively include determining the fill level of one or more images (e.g., all images to be sorted, or a subset thereof) in one or more manners distinct from those described herein regarding the method 10. In specific examples, the fill level(s) can be determined by human classifiers (e.g., based on the image(s) and/or on any other suitable information), by other computerized image analysis methods (e.g., using other statistical classifiers, machine learning techniques, and/or computer vision techniques), based on auxiliary information (e.g., sensor information associated with the containers and/or images, such as weight information, proximity sensor information, etc.), and/or in any other suitable manner.

In some examples, the method for contamination assessment described in U.S. patent application Ser. No. 17/145,021 can additionally or alternatively include training one or more statistical classifiers, machine learning elements, and/or computer vision elements (e.g., as described therein regarding ‘training an image classifier S700’). For example, the method for contamination assessment described in U.S. patent application Ser. No. 17/145,021 can include training one or more neural networks (e.g., deep neural network, convolutional neural network, etc.) to detect contaminants depicted in images (e.g., images of container contents such as described herein and/or any other suitable images). In a specific example, such training can include receiving images (e.g., images of container contents such as described herein) and associated image labels indicative of contaminant contents depicted in the images (e.g., one or more quantity metrics, such as count, volume, weight, etc., associated with one or more specific contaminant types such as bulky items and/or black bags, with overall contaminants, and/or with any suitable subsets thereof), and using these images to perform the training (e.g., using the associated image labels to direct the training). The received images can be images captured by images sensors (e.g., as described above regarding the container contents images), generated images (e.g., generated by artificially adding depictions of one or more contaminants to captured images, generated entirely artificially, etc.), and/or any other suitable images.

However, the method can additionally or alternatively include any other suitable elements performed in any suitable manner.

Although omitted for conciseness, the preferred embodiments include every combination and permutation of the various system components and the various method processes. Furthermore, various processes of the preferred method can be embodied and/or implemented at least in part as a machine configured to receive a computer-readable medium storing computer- readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer- executable component is preferably a general or application specific processing subsystem, but any suitable dedicated hardware device or hardware/firmware combination device can additionally or alternatively execute the instructions.

The FIGURES illustrate the architecture, functionality and operation of possible implementations of systems, methods and computer program products according to preferred embodiments, example configurations, and variations thereof. In this regard, each block in the flowchart or block diagrams may represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

1-21. (canceled)

22. A method for characterizing waste within containers, the method comprising:
training a fullness metric classifier with a plurality of reference images, wherein each reference image of the plurality of reference images depicts a reference container interior comprising a target fullness state of waste;
receiving, via the fullness metric classifier, a subject image generated by a content sensor positioned within a subject container, wherein the subject image depicts an interior of the subject container in a current fullness state of waste;
comparing, via the fullness metric classifier, the current fullness state of waste of the subject image to the target fullness state of waste of a first reference image of the plurality of reference images; and
determining, via the fullness metric classifier, a fullness metric associated with the interior of the subject container based on the comparison.

23. The method of claim 22, further comprising:
selecting, via the fullness metric classifier, the first reference image from the plurality of reference images based on the received subject image.

24. The method of claim 22, further comprising:
receiving, via the fullness metric classifier, data indicative of a trigger event, wherein determining the fullness metric associated with the interior of the subject container is further based on the data indicative of a trigger event.

25. The method of claim 24, wherein the data comprises a user request to assess the subject image.

26. The method of claim 24, wherein the data indicative of a trigger event is generated by an auxiliary sensor.

27. The method of claim 26, wherein the auxiliary sensor comprises an IMU sensor, a geopositioning element, a weight sensor, or an audio sensor, or combinations thereof.

28. The method of claim 22, further comprising:
receiving, via the fullness metric classifier, a plurality of subject images generated by the content sensor, wherein each subject image of the plurality of subject images depicts the interior of the subject container throughout a time series, wherein determining the fullness metric associated with the interior of the subject container is further based on the plurality of subject images.

29. The method of claim 28, further comprising:
determining, via the fullness metric classifier, a reduction in the fullness state of waste within the interior of the subject container based on the plurality of subject images

30. The method of claim 29, further comprising:
determining, via the fullness metric classifier, that the reduction in the fullness state of waste within the interior of the subject container is significant; and
determining, via the fullness metric classifier, that a service event occurred based on the determination that the reduction in the fullness state of waste within the interior of the subject container is significant.

31. The method of claim 30, further comprising:
implementing, via the fullness metric classifier, an action in response to the determination that a service event occurred.

32. The method of claim 31, wherein the action comprises storing the plurality of subject images or providing the plurality of subject images to a user, or combinations thereof.

33. The method of claim 22, further comprising:
receiving, via the classifier, data indicative of a container service schedule, wherein determining the fullness metric associated with the interior of the subject container is further based on the data indicative of the container service schedule.

34. The method of claim 22, further comprising:
assessing, via the fullness metric classifier, contamination within the interior of the subject container based on the comparison.

35. The method of claim 34, wherein assessing the contamination comprises:
determining, via the fullness metric classifier, a quantity metric associated with the contamination within the interior of the subject container.

36. The method of claim 35, wherein the quantity metric comprises a count, volume, or a weight of contamination within the interior of the subject container, or combinations thereof.

37. The method of claim 36, wherein assessing the contamination comprises:
determining, via the fullness metric classifier, a type of contamination within the interior of the subject container.

38. The method of claim 37, wherein the type of contamination comprises a bulky item or a bag within the interior of the subject container.

39. A system configured to characterize waste within containers, the system comprising:
a content sensor; and
a computing system communicatively coupled to the content sensor and configured to execute a fullness metric classifier, wherein the fullness metric classifier is configured to:
receive a subject image from the content sensor positioned within a subject container, wherein the subject image depicts an interior of the subject container in a current fullness state of waste;
compare the current fullness state of waste of the subject image to a target fullness state of waste of a first reference image of a plurality of reference images; and
determine a fullness metric associated with the interior of the subject container based on the comparison.

40. A method for characterizing waste within containers, the method comprising:
training a classifier with a plurality of reference images, wherein each reference image of the plurality of reference images depicts a reference container interior comprising a target state of waste;
receiving, via the classifier, a subject image generated by a content sensor positioned within a subject container, wherein the subject image depicts an interior of the subject container in a current state of waste;
comparing, via the classifier, the current state of waste of the subject image to the target state of waste of a first reference image of the plurality of reference images; and
characterizing, via the classifier, waste within the interior of the subject container based on the comparison.

41. The method of claim 40, wherein characterizing the waste within the interior of the subject container comprises:
determining, via the classifier, a fullness metric associated with the interior of the subject container based on the comparison; or
assessing, via the classifier, contamination within the interior of the subject container based on the comparison, or combinations thereof.
